(19) United States
(12) Patent Application Publication
(10) Pub. No.: US 2026/0280604 A1
(43) Pub. Date: Sep. 17, 2026

(54) Primary connection part, in particular plug-in connection part, for a connecting device for inductively transmitting signals, set, connecting device and measuring device

(71) Applicant: Knick Elektronische Messgeräte GmbH & Co. KG, Berlin (DE)

(72) Inventor: Harald ZANK, Berlin (DE)

(73) Assignee: Knick Elektronische Messgeräte GmbH & Co. KG, Berlin (DE)

(21) Appl. No.: 19/165,125

(22) PCT Filed: Mar. 12, 2024
(86) PCT No.: PCT/EP2024/056561

§ 371 Date: Sep. 14, 2025

(30) Foreign Application Priority Data
Mar. 16, 2023 (DE) 10 2023 202 369.5

(51) Int. Cl. H04B 5/26

(52) U.S. Cl. CPC H04B 5/266

(57) ABSTRACT

A primary connection part (4.2), in particular a plug-in connection part, for a connecting device (2.2) for inductively transmitting signals includes a primary circuit (19.2), a primary coil unit (21.2) in the primary circuit (19.2), with a primary coil (13.2) for inductive coupling with a secondary coil (11), and at least one compensation means (31) for adjusting the coupling characteristics of the primary coil unit (21.2) to reference coupling characteristics. A set, a connecting device (2.2) and a measuring device (1.2) with at least one such primary connection part (4.2).

### CROSS-REFERENCE TO RELATED APPLICATION

This application is a national stage application, filed under 35 U.S.C. § 371, of International Patent Application PCT/EP 2024/056561, filed on Mar. 12, 2024. The present patent application claims the priority of the German patent application DE 10 2023 202 369.5, filed Mar. 16, 2023, the contents of which are incorporated herein by reference.

### TECHNICAL FIELD

The disclosure relates to a primary connection part, in particular a plug-in connection part, for a connecting device for inductively transmitting signals. The disclosure further relates to a set with at least one such primary connection part. The disclosure also relates to a connecting device with at least one such primary connection part. The disclosure also concerns a measuring device with such a connecting device.

### BACKGROUND

DE 10 2017 113 420 A1 discloses a connecting device for inductively transmitting signals between a primary connection part and a secondary connection part. The signal transmission requires the coupling characteristics of the two connection parts to be precisely matched. Even minor structural changes can lead to deviating coupling characteristics, which prevent the compatibility of corresponding connection parts and can make it necessary to replace large numbers of existing connection parts at great cost.

### SUMMARY

It is an object of the disclosure to create an improved primary connection part for a connecting device for inductively transmitting signals, which is particularly flexible in use and robust and economical in operation.

This object is achieved by a primary connection part as disclosed and claimed. It has been recognised that a primary connection part for a connecting device for inductively transmitting signals is particularly flexible in use and robust and economical in operation if the primary coil unit has at least one compensation means, which is designed to adjust the coupling characteristics of the primary coil unit to reference coupling characteristics. The reference coupling characteristics are preferably determined by the fact that they ensure inductive signal transmission via the connecting device, in particular between the primary connection part and a secondary connection part, in a particularly energy-efficient manner and/or with a particularly high degree of robustness against disruptive influences, such as contamination and/or wear effects. The reference coupling characteristics can correspond to the coupling characteristics of a reference primary connection part, which guarantees a reliable signal transmission with the secondary connection part. Primary connection parts at different development stages can be reliably used with the same secondary connection part by virtue of the fact that the compensation means ensures that the coupling characteristics of the primary coil unit are adjusted to the reference coupling characteristics. This allows the primary connection part to be technically refined without compatibility issues, revised in line with changing customer requirements, and flexibly manufactured using commercially available and economically procurable components, in particular electronic components. The compensation means ensures that the coupling characteristics can be adjusted particularly precisely to the reference coupling characteristics, whereby the signal transmission is particularly efficient and resistant to interference in operation.

The terms “primary” and “secondary” are used to establish an assignment to one of the two sides of a transformer coil pair that interact in inductive signal transmission, in particular to the primary coil side and/or the secondary coil side. The inductive signal transmission is, in principle, direction-independent. The terms primary and secondary should therefore be understood as interchangeable. The primary side is preferably on the power supply side. The secondary side can be arranged on the consumer side, in particular a sensor. Alternatively, a reverse arrangement is possible. In principle, both the primary connection part and the secondary connection part can have at least one compensation means for adjusting respective reference coupling characteristics.

The coupling characteristics are understood as all characteristics affecting the coupling ability of the primary connection part, in particular in a connection with the secondary connection part. The coupling characteristics comprise in particular the electrical properties of the electrical components of the primary connection part that influence the inductive signal transmission. The coupling characteristics can be determined by the resistors, inductors, capacitors and/or semiconductors, in particular switches and/or diodes, integrated in the primary circuit, in particular in a resonant circuit for exciting the primary coil.

The primary circuit preferably comprises a resonant circuit for cyclically exciting an electric current through the primary coil, in particular for applying an alternating voltage to the primary coil. The primary circuit preferably has an amplifier circuit, in particular a Class E amplifier. The resonant circuit can be part of the amplifier circuit.

The signals, which can be transmitted inductively, can comprise energy and/or information. The primary connection part is preferably designed to transmit electrical energy to the secondary coil via the primary coil for operating a secondary connection part, in particular a secondary connection circuit. The transmitted electrical energy can in particular be used to supply, in particular additional, consumers, in particular at least one sensor. The information can comprise digital and/or analogue signals, in particular data, in particular measurement data, in particular sensor data.

The primary coil unit comprises the primary coil and the at least one compensation means. The primary coil unit can further have a coil core, in particular a ferrite core, a coil former, and/or a housing, in particular a section of the primary housing of the primary connection part.

The disclosure relates in particular to a method for adjusting the coupling characteristics of the primary connection part, in particular the primary coil unit, to the reference coupling characteristics. The method is preferably further developed with at least one of the features described in connection with the primary connection part. The advantages of the method correspond to the advantages of the primary connection part. The coupling characteristics are preferably adjusted in such a way that the coupling behaviour of the primary connection part matches that of the secondary connection part.

According to one aspect, the primary connection unit comprises a single or at least one, in particular at least two, in particular at least five, compensation means.

According to one aspect, the compensation means is designed to compensate for a change in design of the primary coil unit. The change in design can comprise a change to components of the primary circuit and/or a change to elements interacting therewith, for example the coil core and/or the housing and/or the coil former. The change in design can in particular be a change in the primary coil unit, in particular the primary coil, in relation to a reference primary coil unit, in particular a reference primary coil, of a reference primary connection part. For example, the coil core and/or the coil geometry, in particular the coil wire and/or the coil length and/or the coil diameter and/or the number of windings and/or the winding thickness can be changed. The compensation means is preferably designed in such a way that the coupling characteristics of the primary coil unit are adapted to the changed design, in particular in such a way that the coupling behaviour matches the secondary connection part.

Compensation is understood to mean that a certain, in particular an undesirable effect, is at least partially, in particular completely, counteracted. The change in design leads to a change in the coupling characteristics, which is counteracted by the compensation means.

According to one aspect, the change in design of the primary coil unit comprises a design modification and/or redesign of the primary coil unit. The change in design is in particular a change, in particular a deliberate change, in relation to the design of a reference primary coil unit. For example, the change in design can comprise a change in geometry and/or the addition, removal and/or rearrangement of components of the primary coil unit, in particular the coil core and/or coil former.

The change in design does not mean any incidental deviations that are solely attributable to component tolerances. Unlike a change in design, component tolerances often have a minor influence on inductive coupling behaviour, but in any case an influence that varies across a plurality of primary coil units of the same design. The influence of a change in design on inductive coupling behaviour is not variable and can therefore be precisely determined. The compensation means can be designed in such a way that it is used to compensate for an influence of a change in design on the inductive coupling behaviour, in particular in relation to the reference primary coil unit, which influence does not vary in particular across a plurality of primary connection parts, in particular primary coil units, of the same design.

According to another aspect, the primary coil unit has the compensation means, in particular in the primary circuit, and the reference primary coil unit does not have a compensation means, in particular does not have a corresponding compensation means. The compensation means is preferably designed to compensate for the change in design of the primary coil unit in relation to the reference primary coil unit.

According to one aspect, the at least one compensation means can be designed to compensate for a change in dimension of the primary coil. The change in dimension can relate to the length and/or width, in particular diameter, and/or the cross-sectional geometry and/or wire geometry, in particular the wire length, and/or the number of windings and/or winding thickness.

According to one aspect, the at least one compensation means can be designed to compensate for a change in the coupling characteristics which result depending on the use of a coil former for the primary coil. The reference coupling characteristics can correspond to those of a primary coil unit with a coil former or a primary coil unit designed without a coil former. The compensation means can be designed to provide corresponding reference coupling characteristics without a corresponding coil former and/or with a corresponding coil former. In a primary coil unit without a coil former, the primary coil can be wound directly onto the coil core, in particular the ferrite core, or manufactured to be self-stable and combined with the coil core. A primary coil wound onto a coil former has improved mechanical properties and is easier to handle in production. Depending on the use of a coil former, this may result in a change to the primary coil, with a corresponding influence on the coupling characteristics. The compensation means is preferably designed to compensate for the change in the coupling characteristics resulting from the change in geometry of the primary coil caused by the coil former.

According to one aspect, the primary coil unit can have a coil former for supporting the primary coil, wherein the at least one compensation means is designed to counteract the change in the coupling characteristics caused by the use of the coil former. Depending on the use of the coil former, a change to the coil core may be required, in particular a change to the geometry of the coil core. The compensation means can be designed to compensate for an in particular resulting change in the coupling characteristics.

According to one aspect, the at least one compensation means is electrically connected to the primary circuit. The compensation device can be electrically connected to the primary circuit, in particular in a series connection and/or a parallel connection with the primary coil. The compensation means can comprise a resistor and/or a capacitor.

According to one aspect, the at least one compensation means is permanently connected to the primary circuit. This is understood to mean that the compensation means is permanently connected to the primary circuit in an electrically conductive manner, i.e. it cannot be switched off. The compensation means is preferably an electrical component.

According to one aspect, the compensation means can be designed to be unchangeable, in particular non-switchable and/or non-adjustable, in particular connected to the primary circuit. The compensation means may be a component whose properties, in particular its electrical properties, cannot be changed and/or cannot be changed reversibly. The compensation means is preferably not designed to compensate for component tolerances, but rather to compensate for a change in design. It is not necessary to adjust the compensation means in this case. A primary connection part with such a compensation means can be manufactured in a particularly cost-effective manner.

According to one aspect, the at least one compensation means is designed to adjust the inductance of the primary coil unit and/or the coupling factor present during interaction with the secondary coil unit. The compensation means can comprise a component of the coil core and/or the coil winding of the primary coil. By way of example, the length of the coil core can be changed and/or the number of windings can be changed in order to adjust the coupling characteristics to the reference coupling characteristics.

According to one aspect, the at least one compensation means can have a compensation inductor. The compensation means preferably consists of the compensation inductor. The compensation inductor is preferably designed to adjust the electrical properties of the primary circuit, in particular the resonant circuit for supplying the primary circuit with an alternating voltage, to reference properties. The compensation inductor can be designed to adjust the overall electrical inductance in the resonant circuit to that of a reference resonant circuit.

According to one aspect, a ratio of the electrical inductance of the compensation inductor to the electrical inductance of the primary coil is in a range of 1:1000 to 1:1, in particular 1:500 to 1:2, in particular 1:100 to 1:5, in particular 1:60 to 1:10. The electrical inductance of the compensation inductor is preferably in a range of 0.1 μH to 10 mH, in particular 1 μH to 1 mH, in particular 10 μH to 500 μH, in particular 50 μH to 250 μH. As a result, the coupling characteristics can be influenced in a particularly flexible and precise manner.

According to one aspect, the inductance of the primary coil is in a range of 1 μH to 100 mH, in particular 10 μH to 10 mH, in particular 100 μH to 1 mH. This guarantees particularly robust and efficient signal transmission.

According to another aspect, the at least one compensation means, in particular the compensation inductor, is arranged substantially outside a coupling region of the primary coil and/or is designed to be magnetically independent, in particular is arranged magnetically independently from the primary coil. The coupling region is understood to be an immediate vicinity of the primary coil. The coupling region is preferably determined by the fact that it has a distance to the primary coil which corresponds to no more than twice the length of the primary coil and/or no more than five times, in particular no more than twice, in particular no more than once, the diameter of the primary coil. The coupling region can be delimited by the smallest convex hull, which encloses the primary coil and the secondary coil in a transmission arrangement. In the transmission arrangement, the primary coil is preferably positioned in the arrangement intended for signal transmission relative to the secondary coil. The compensation inductor is preferably arranged outside the coupling region; in particular, no current required for signal transmission is directly induced in it. The compensation inductor does not in particular provide a winding that needs to be taken into account in the transformer coupling between the primary coil and the secondary coil.

Alternatively, the compensation means, in particular the compensation inductor, can be arranged inside the coupling region.

The magnetic axes of the primary coil and/or secondary coil can be oriented parallel to the magnetic axis of the compensation coil and/or oriented obliquely thereto, in particular at an angle of at least 10°, in particular at least 30°, in particular at least 60°, in particular 90°. The oblique arrangement reduces the electromagnetic interaction between the coils.

The compensation coil can have an electric and/or magnetic shield.

Another object of the disclosure is to create an improved set for a connecting device for inductively transmitting signals, which is particularly flexible in use and robust and economical in operation.

This object is achieved by a set having at least one reference primary connection part, in particular a reference plug-in connection part, with a reference primary circuit, and a reference primary coil unit in the reference primary circuit with reference coupling characteristics, and at least one primary connection part as disclosed above. The compensation means adjusts the coupling characteristics of the primary coil unit to the reference coupling characteristics. The advantages of the set correspond to the advantages of the primary connection part described above. The set can in particular be further developed with at least one of the features described above in connection with the primary connection part.

Apart from the primary coil unit, the reference primary connection part can correspond substantially to the primary connection part. The reference primary connection part preferably has a reference primary coil unit with reference coupling characteristics which match the secondary connection part, in particular which guarantee the inductive signal transmission to the secondary connection part in a reliable manner.

The compensation means is preferably designed in such a way that the coupling characteristics of the primary connection part, in particular the primary coil unit, correspond substantially to the reference coupling characteristics of the reference primary connection part, in particular the reference primary coil unit, in particular in terms of the achievable coupling factor. A difference between the coupling characteristics of the reference primary connection part and the primary connection part, in particular in terms of the coupling factor, is preferably no more than 50%, in particular no more than 20%, in particular no more than 10%, in particular no more than 5%, in particular no more than 2%, in particular no more than 1%. Without the compensation means, the coupling characteristics of the reference connection part and the connection part preferably differ, in particular with respect to the coupling factor, by at least 1%, in particular by at least 5%, in particular by at least 10%, in particular by at least 20%, in particular by at least 30%, in particular by at least 50%, and/or by no more than 60%, in particular when using the same secondary connection part.

According to one aspect, the set comprises at least two, in particular at least three, in particular at least five, in particular at least ten, reference primary connection parts and/or at least two, in particular at least three, in particular at least five, in particular at least ten, primary connection parts.

Another object of the disclosure involves providing an improved connecting device for inductively transmitting signals, which is particularly flexible in use and robust and economical in operation.

This object is achieved by a connecting device having at least one primary connection part or a set as disclosed above, and at least one secondary connection part with at least one secondary coil for inductive coupling with the primary coil and/or with a reference primary coil of the reference primary coil unit. The advantages of the connecting device correspond to the advantages of the primary connection part and/or set. The connecting device can be further developed with at least one of the features described above in connection with the primary connection part and/or set.

All primary connection parts, in particular comprising the reference primary connection parts, are preferably compatible with the same secondary connection part.

This eliminates the need to distinguish between combinations of connection parts that are exclusively compatible with each other. Faulty connections are thus eliminated.

The reference primary connection part preferably has a different structure to the primary connection part; in particular, it can be designed without a compensation means for adjusting the coupling characteristics.

The maximum electrical power that can be transmitted via the connecting device is preferably no more than 500 W, in particular no more than 100 W, in particular no more than 10 W, in particular no more than 5 W, in particular no more than 1 W, and/or at least 1 mW, in particular at least 0.5 W, in particular at least 1 W, in particular at least 10 W.

The data rate that can be transmitted via the connecting device is preferably no more than 10 Mbit/s, in particular no more than 1 kbit/s, and/or at least 100 bit/s, in particular at least 1 kbit/s, in particular at least 1 Mbit/s.

According to one aspect, the connecting device is designed as a plug-in connection. The primary connection part can have a plug-in connector. The secondary connection part can have a mating plug-in connector.

The connecting device can have a locking means for mechanically locking the primary connection part against the secondary connection part. The locking means can have a bayonet lock and/or a latching element and/or a locking bolt. The locking means preferably comprises a locking ring, in particular a locking ring mounted to rotate about a central longitudinal axis.

The primary connection part and/or the secondary connection part can have a wired and/or wireless connection, in particular a WiFi, Bluetooth and/or radio connection. The primary connection part preferably has a cable connection, in particular for connection to an electronic evaluation system.

Another object of the disclosure is to create an improved measuring device, which is particularly flexible in use and robust and economical in operation.

This object is achieved by a measuring device having at least one sensor, and a connecting device as disclosed above for transmitting sensor signals. The advantages of the measuring device correspond to the advantages of the primary connection part, set or connecting device. The measuring device is preferably further developed with at least one of the features described above in connection with the primary connection part, set and/or connecting device. The sensor can be attached to the primary connection part and/or the secondary connection part, in particular rigidly and/or flexibly, in particular via a cable, and connected thereto. The sensor is preferably connected to the secondary connection part and the primary connection part has a cable connection for connection to an electronic evaluation system.

The at least one sensor can comprise a pH sensor and/or a temperature sensor and/or a pressure sensor and/or a humidity sensor and/or a redox sensor and/or an oxygen sensor and/or a conductivity sensor and/or a liquid sensor and/or a gas sensor and/or an optical sensor, in particular for detecting turbidity and/or fluorescence and/or an optically functioning liquid sensor, and/or a sensor for detecting ozone, free chlorine, free bromine, chloride dioxide, total chlorine, Polycyclic Aromatic Hydrocarbons (PAHs, optical) and/or nitrate (optical) and/or a SAC measurement sensor and/or a sensor for detecting a level and/or a boundary layer and/or an ultrasonic sensor and/or an ion-selective sensor, in particular a cation-selective sensor, and/or an amperometric sensor and/or a potentiometric sensor. The at least one sensor is preferably formed integrally with the primary connection part and/or secondary connection part.

The primary connection part, set, connecting device and/or measuring device can be specially designed for use in a potentially explosive atmosphere.

The primary connection part and/or secondary connection part can have a processing unit, in particular a microcontroller for processing data, in particular measurement data from the sensor.

For further details on the embodiment of the at least one sensor and/or connecting device, reference is made to DE 10 2017 113 420 A1, the contents of which are incorporated herein by reference.

Further features, details and advantages of the invention result from the following description of an exemplary embodiment based on the figures. In the drawing:

### BRIEF DESCRIPTION OF THE DRAWINGS

FIG. 1 shows a perspective, partially sectional view of a reference connecting device for inductively transmitting signals, having a secondary connection part and a reference primary connection part with a reference primary coil wound directly onto a ferrite core.

FIG. 2 shows a schematic circuit diagram of the reference connecting device shown in FIG. 1.

FIG. 3 shows a perspective, partially sectional view of a connecting device for inductively transmitting signals, having the secondary connection part and a primary connection part with a primary coil wound onto a coil former and a compensation means for adjusting coupling characteristics to reference coupling characteristics.

FIG. 4 shows a schematic circuit diagram of the connecting device shown in FIG. 3.

FIG. 5 shows a top view of the coil former shown in FIG. 3.

### DETAILED DESCRIPTION

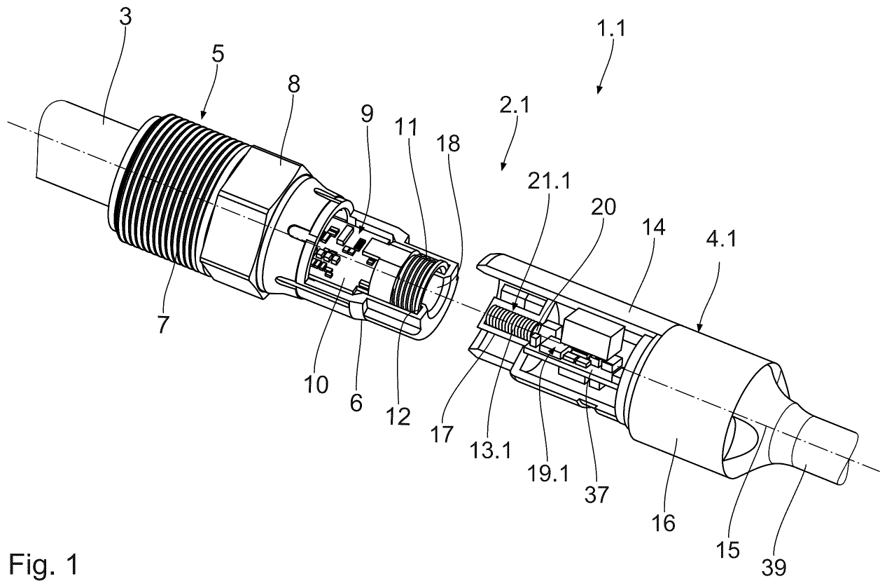

An exemplary embodiment of a measuring device 1.1, 1.2 with a connecting device 2.1, 2.2 and a sensor 3 connected thereto is described with reference to FIG. 1 to FIG. 5.

The sensor 3 is designed as a pH sensor. The sensor 3 can alternatively or in addition be designed as a redox sensor, a conductivity sensor, an oxygen sensor, a temperature sensor and/or a pressure sensor.

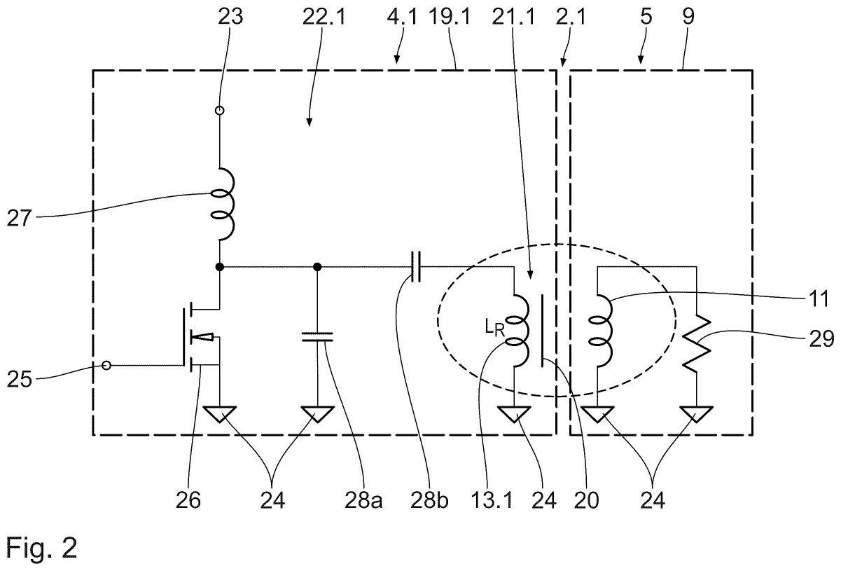

The reference connecting device 2.1 described with reference to FIG. 1 and FIG. 2 has a reference primary connection part 4.1 and a secondary connection part 5. The sensor 3 is rigidly connected to the secondary connection part 5.

The secondary connection part 5 has a secondary housing 6 with a thread 7, in particular an external thread. The thread 7 is designed to fasten the secondary connection part 5 to a measuring point. The thread 7 is in particular designed in such a way that the secondary connection part 5 can be attached to a measuring chamber wall such that the sensor 3 is arranged in the measuring chamber and the secondary connection part 5 is arranged at least in sections outside the measuring chamber, wherein the measuring chamber wall is sealed by the secondary connection part 5, in particular a sealing element, preferably in a fluid-tight manner, in particular in a gas-tight manner. The secondary housing 6 has a tool interface 8 for driving the secondary connection part 5 in rotation, in particular for screwing the thread 7 to the measuring chamber wall.

The secondary connection part 5 comprises a secondary circuit 9, which is preferably at least partially formed on a secondary circuit board 10. A secondary coil 11 is formed in the secondary circuit 9. The secondary coil 11 is part of an inductive coupling path for the transformer-based transmission of signals, in particular energy and information.

The secondary coil 11 is wound onto a secondary coil former 12. The secondary coil former 12 is in the form of a hollow cylinder. An in particular cylindrical primary coil 13.1 of the reference primary connection part 4.1 can be inserted at least in sections and reversibly into the cylindrical central recess 18 of the secondary coil former 12.

The secondary housing 6 encloses the secondary circuit 9 with the secondary coil 11 preferably in a fluid-tight, in particular gas-tight manner.

In order to mechanically connect the reference primary connection part 4.1 to the secondary connection part 5, these interact in the form of a plug-in connection. A locking mechanism prevents the plug-in connection from becoming disconnected, in particular unintentionally. The locking mechanism is designed as a bayonet lock. The locking mechanism comprises a locking sleeve 14, which can be rotated about a central longitudinal axis 15 of the reference primary connection part 4.1 and is furthermore fixedly attached to a primary housing 16 of the reference primary connection part 4.1.

The primary housing 16 of the reference primary connection part 4.1 has a cylindrical protrusion 17 for engaging in the cylindrical recess 18 of the secondary housing 6, which is surrounded by the secondary coil former 12 or secondary coil 11.

The reference primary connection part 4.1 comprises a reference primary circuit 19.1, in which a reference primary coil 13.1 is integrated. The reference primary coil 13.1 is wound onto a ferrite core 20, in particular directly. The reference primary coil 13.1 is arranged in the region of the cylindrical protrusion 17, in particular at least partially, in particular completely. In particular, the reference primary coil 13.1 overlaps the cylindrical protrusion 17 in an orthogonal projection onto a plane oriented parallel to the central longitudinal axis 15.

A reference primary coil unit 21.1 comprises the reference primary coil 13.1 and the ferrite core 20, in particular the reference primary coil unit 21.1 consists thereof. The reference primary coil unit 21.1 has an electrical inductance LR of 500 μH.

A schematic circuit diagram of the reference connecting device 2.1 is described with reference to FIG. 2. The reference primary circuit 19.1 has a reference amplifier circuit 22.1, which is preferably designed as a Class E amplifier. The reference amplifier circuit 22.1 comprises a supply voltage connection 23, earth connections 24 and a carrier frequency connection 25. The carrier frequency connection 25 is connected to the gate connection of a transistor 26 of the reference amplifier circuit 22.1. The earth connection 24 is connected to the source connection and the supply connection 23 is connected to the drain connection of the transistor 26. The reference amplifier circuit 22.1 further has an amplifier inductor 27 and two amplifier capacitors 28a, 28b.

The reference primary coil 13.1, in particular further the amplifier capacitors 28a, 28b, are part of an electrical resonant circuit, which in particular is excited by means of the transistor switched via the carrier frequency connection 25.

The reference primary connection part 4.1, in particular the reference primary coil unit 21.1 has reference coupling characteristics, in particular during interaction with the secondary connection part 5. The reference coupling characteristics have an influence on the transmission behaviour of the reference connecting device 2.1 in terms of the signals to be inductively transmitted. The reference coupling characteristics are in particular determined by the electrical inductance L_{R} of the reference primary coil unit 21.1 and/or the reference coupling factor k_{R} resulting from interaction with the secondary connection part 5. The reference coupling characteristics are in particular essential for the inductive signal transmission, in particular for the response behaviour of the electrical resonant circuit, for inductive coupling between the reference primary circuit 19.1 and the secondary circuit 9 and/or for the functionality and robustness of signal processing connected to the reference primary circuit 19.1 and/or to the secondary circuit 9.

The secondary circuit 9 is represented by an equivalent resistor 29, which comprises corresponding signal processing, in particular having the sensor 3.

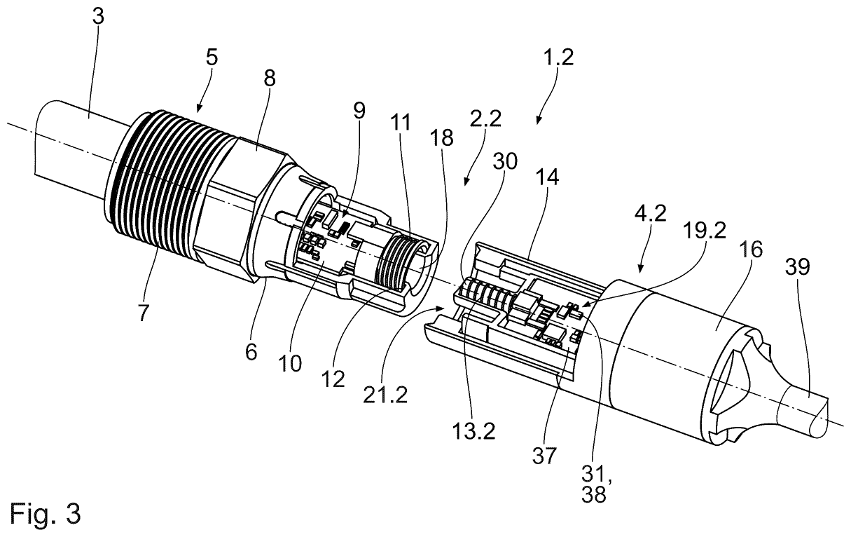

The connecting device 2.2 described with reference to FIG. 3 to FIG. 5 has a primary connection part 4.2. The structure of the primary connection part 4.2 largely corresponds to the structure of the reference primary connection part 4.1. The primary connection part 4.2 is, like the reference primary connection part 4.1, designed to establish a reversibly releasable connection for inductively transmitting signals with the secondary connection part 5. Unlike the reference primary connection part 4.1, the primary coil 13.2 of the primary connection part 4.2 is wound onto a coil former 30. The primary coil unit 21.2 of the primary connection part 4.2 has a compensation means 31 for adjusting the coupling characteristics of the primary coil unit 21.2 to the reference coupling characteristics of the reference primary connection part 4.1, in particular the reference primary coil unit 21.1.

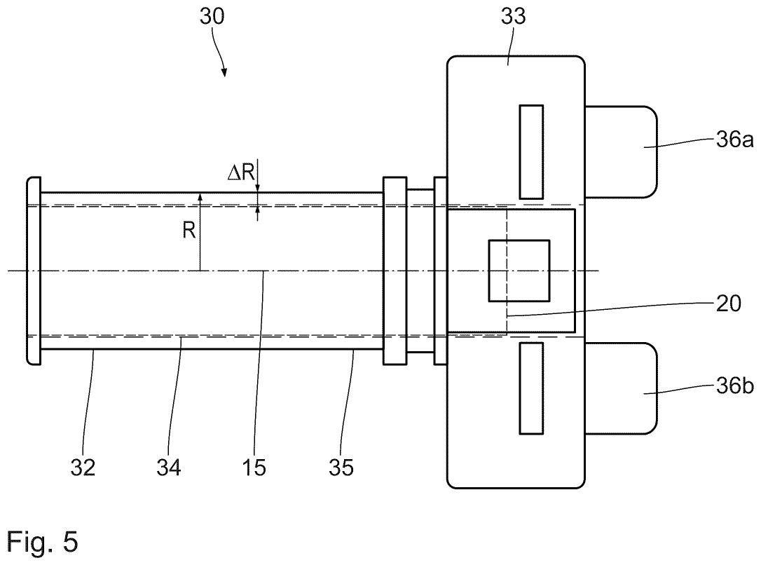

The coil former 30 is further described in detail with reference to FIG. 5. The coil former 30 comprises a winding section 32 and a connection section 33. The coil former 30 has a receiving space 34 for a ferrite core 20. The receiving space 34 can be designed as a blind hole or through-hole. A winding surface 35 of the winding section 32 is designed in the shape of a cylindrical shell.

The coil former 30 comprises coil connections 36a, 36b for electrical and/or mechanical connection to the primary circuit 19.2 and/or a primary circuit board 37 at least partially carrying the primary circuit 19.2.

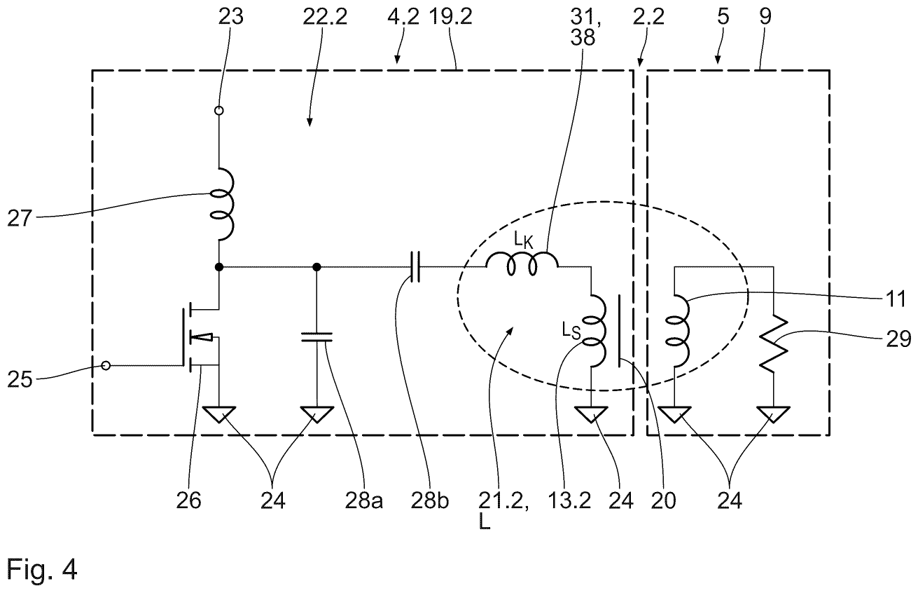

A schematic circuit diagram of the reference connecting device 19.2 is described with reference to FIG. 4. The primary circuit 19.2 has an amplifier circuit 22.2, in particular a Class E amplifier.

The amplifier circuit 22.2 of the primary connection part 4.2 corresponds substantially to the reference amplifier circuit 22.1 of the reference primary connection part 4.1. However, there is a changed electrical inductance Ls of the primary coil 13.2 relative to the reference primary coil 13.1 owing to the changed arrangement of the primary coil 13.2 relative to the ferrite core 20 or relative to the secondary coil 11 caused by the coil former 30.

The primary coil 13.2 is arranged at a greater radial distance R to the longitudinal axis 15 due to the use of the coil former 30. The primary coil 13.2 has a radial distance AR to the ferrite core 30. The primary coil 13.2 is arranged closer to the secondary coil 11 in the radial direction than the reference primary coil 13.1, whereby the magnetic coupling of the secondary coil 11 to the primary coil 13.2 is more pronounced than to the reference primary coil 13.1. In particular, the electrical inductance Ls and coupling factor k_{R} change, which, as described above, can impair the compatibility of the primary coil unit 21.2. Generally speaking, the changed electrical properties L_{S}, k_{R} cannot be restored solely by changing the number of windings of the primary coil 13.2. A change to the ferrite core 20 used would also be insufficient. Its custom manufacturing would also be uneconomical.

The electrical inductance L of the primary coil unit 21.2 comprises the electrical inductance L_{S} of the primary coil 13.2. In order to compensate for the geometric differences present in relation to the reference primary coil unit 21.1, in particular the resulting changes in the characteristics of the transformer, in particular in terms of the inductance L_{S} of the primary coil 13.2, in particular during interaction with the secondary coil 11, in particular in terms of the leakage inductance, the primary coil unit 21.2 has the compensation inductor 38 with the electrical inductance L_{K}. The electrical inductance L_{K} is designed in such a way that the coupling characteristics of the primary coil unit 21.2 substantially correspond to those of the reference primary coil unit 21.1, in particular in such a way that the electrical inductance L of the primary coil unit 21.2 substantially corresponds to the electrical inductance L_{R} of the reference primary coil unit 21.1.

With more pronounced magnetic coupling due to the primary coil 13.2, the leakage inductance is reduced relative to the reference primary coil 13.1 during interaction with the secondary coil 11. The compensation coil Lₖ is used to compensate for the decreasing leakage inductance. The size of the compensation inductance Lₖ is particularly preferably dimensioned such that approximately the same electrical conditions arise as in the situation without changed mechanical dimensions, in particular the same leakage inductance.

Without the electrical inductance L_{K} of the compensation inductor 38, the electrical inductance L of the primary coil unit 21.2 would be lower than the electrical inductance L_{R} of the reference primary coil unit 21.1, which would result in a modified transmission behaviour between the secondary connection part 5 and the primary connection part 4.2 relative to the transmission behaviour between the secondary connection part 5 and the reference primary connection part 4.1. In particular, the excitation behaviour of the resonant circuit formed by the respective amplifier circuit 22.1, 22.2 would be different. The compensation means 31 adjusts the coupling characteristics of the primary connection part 4.2, in particular the primary coil unit 21.2, to the reference coupling characteristics of the reference primary connection part 4.1, in particular the reference primary coil unit 21.1.

The compensation inductor 38 preferably has an electrical inductance L_{K} in a range of 1% to 50%, in particular 25%, of the inductance L of the primary coil 13.2. The electrical inductance L_{K} of the compensation inductor 38 is preferably in a range of 1 μH to 500 μH, in particular 250 μH. The total of the electrical inductance L of the primary coil 13.2 and the electrical inductance L_{K} of the compensation inductor 38 preferably substantially corresponds to the reference inductance L_{K} of the reference primary coil 13.1.

The compensation means 31 advantageously ensures that despite a changed design of the primary connection part 4.2 relative to the reference connection part 4.1, in particular a changed electrical design, which in particular would lead to changed coupling characteristics, the primary connection part 4.2 interacts reliably and in an energy-efficient manner with the secondary connection part 5.

The primary connection part 4.2 and the reference primary connection part 4.1 together form a set for reversible connection with the secondary connection part 5, in particular in the form of a plug-in connection. Respectively one primary connection part 4.1, 4.2 forms together with the secondary connection part 5 the connecting device 2.1, 2.2 for inductively transmitting signals.

The primary connection part 4.1, 4.2 can be connected to an evaluation device by means of a cable connection 39 or wirelessly, in particular by radio, WiFi and/or Bluetooth. The secondary connection part 5 and/or sensor 3 is preferably supplied with power via the primary connection part 4.1, 4.2, in particular via the primary coil 13.1, 13.2, in particular provided by the evaluation device.

The respective measuring device 1.1, 1.2, the respective connecting device 2.1, 2.2, the set or the respective primary connection part 4.1, 4.2 function as follows:

The secondary connection part 5 is initially separated from the respective primary connection part 4.1, 4.2. The thread 7 is screwed to a measuring chamber wall. The sensor is designed as a pH sensor and arranged in the measuring chamber, in particular at a measuring point. The secondary coil 11 is arranged outside the measuring chamber, in particular spaced apart from the measuring chamber wall. The secondary connection part 5 is ready for reversible connection to the primary connection part 4.1, 4.2.

In order to inductively transmit signals between the secondary connection part 5 and one of the primary connection parts 4.1, 4.2, these are plugged together. The primary coil 13.1, 13.2, in particular the cylindrical protrusion 17 of the primary housing 16, is inserted into the secondary coil 11, in particular into the cylindrical recess 18 of the secondary housing 6. The plug-in connection is locked by means of the locking sleeve 14. The locking sleeve 14 is rotated about the central longitudinal axis 15, in particular relative to the primary housing 16. A form-fitting connection is established, which preferably comprises a locking protrusion, which engages in a locking groove.

The plug-in connection forms a mechanical connection between the secondary connection part 5 and the primary connection part 4.1, 4.2. At the same time, a connection is established for inductively transmitting signals, in particular energy and information, by the arrangement of the primary coil 13.1, 13.2 in the secondary coil 11.

By virtue of the fact that the primary connection part 4.2 has the compensation means 31, the coupling characteristics of the primary connection part 4.2, in particular the primary coil unit 21.2, substantially correspond to the reference coupling characteristics of the reference primary connection part 4.1, in particular the reference primary coil unit 21.1. The secondary connection part 5 can thus be used equally reliably and efficiently with the primary connection part 4.2 and with the reference primary connection part 4.1.

Structural changes to the primary connection part 4.2 relative to the reference primary connection part can be undertaken without compatibility issues. Structural changes can also be undertaken on the secondary connection part 5. The terms “primary” and “secondary” are interchangeable. Similarly, the secondary connection part 5 can be formed with a compensation means 31 in accordance with the above description in order to adjust its coupling characteristics to reference coupling characteristics.

The measuring device 1.1, 1.2, the connecting device 2.1, 2.2, the primary connection part 4.1, 4.2 and the set are particularly robust and economical in operation due to their connection compatibility. A faulty connection of incompatible connection parts 4.1, 4.2, 5 is reliably prevented. Existing connection parts 4.1, 4.2, 5 can be re-used without restrictions, in particular without compatibility issues, in particular together with technically improved connection parts 4.1, 4.2, 5. The installation work required to replace corresponding connection parts 4.1, 4.2, 5 is avoided. The compensation means 31 ensures that the coupling characteristics of the primary connection part 4.2, in particular primary coil unit 21.2, can be precisely adapted to the required reference coupling characteristics. The achievable coupling quality is increased.

1.-17. (Canceled)

18. A set for a connecting device (2.1, 2.2) for inductively transmitting signals, comprising:
at least one reference primary connection part (4.1) with
a reference primary circuit (19.1), and
a reference primary coil unit (21.1) in the reference primary circuit (19.1) with
reference coupling characteristics;
at least one primary connection part (4.2) for the connecting device (2.2), having
a primary circuit (19.2), and
a primary coil unit (21.2) in the primary circuit (19.2), with
a primary coil (13.2) for inductive coupling with a secondary coil (11), and
at least one compensation means (31) for adjusting coupling characteristics of the primary coil unit (21.2) to the reference coupling characteristics,
wherein the at least one compensation means (31) is designed to compensate for a change in design of the primary coil unit (21.2) in relation to the reference primary coil unit (21.1).

19. The set according to claim 18,
wherein the at least one compensation means (31) is designed to compensate for a change in dimension (AR) of the primary coil (13.2).

20. The set according to claim 18,
wherein the at least one compensation means (31) is designed to compensate for a change in the coupling characteristic which results depending on a use of a coil former (30) for the primary coil (13.2).

21. The set according to claim 18,
wherein the primary coil unit (21.2) has a coil former (30) for supporting the primary coil (13.2),
wherein the at least one compensation means (31) is designed to counteract the change in the coupling characteristics caused by the use of the coil former (30).

22. The set according to claim 21,
wherein the reference primary coil unit (21.1) is designed without a coil former.

23. The set according to claim 18,
wherein the at least one compensation means (31) is electrically connected to the primary circuit (19.2).

24. The set according to claim 23,
wherein the at least one compensation means (31) is permanently connected to the primary circuit (19.2).

25. The set according to claim 18,
wherein the at least one compensation means (31) is non-switchable and/or non-adjustable.

26. The set according to claim 18,
wherein the at least one compensation means (31) is designed to adjust an electrical inductance (L) of the primary coil unit (21.2).

27. The set according to claim 18,
wherein the at least one compensation means (31) has a compensation inductor (38).

28. The set according to claim 27,
wherein a ratio of an electrical inductance (L) of the compensation inductor (38) to an electrical inductance (Ls) of the primary coil (13.2) is in a range of 1:100 to 1:2.

29. The set according to claim 18,
wherein an electrical inductance (Ls) of the primary coil (13.2) is in a range of 10 μH to 10 mH.

30. The set according to claim 18,
wherein the at least one compensation means (31) is arranged outside a coupling region of the primary coil (13.2).

31. A connecting device (2.2) for inductively transmitting signals, comprising:
at least one set according to claim 18, and
at least one secondary connection part (5) with at least one secondary coil (11) for inductive coupling with the primary coil (13.2) and/or with a reference primary coil (13.1) of the reference primary coil unit (21.1).

32. The connecting device (2.2) according to claim 31,
wherein the connecting device (2.2) is a plug-in connection.

33. A measuring device (1.2), comprising:
at least one sensor (3), and
the connecting device (2.2) according to claim 31 for transmitting sensor signals.

34. A primary connection part (4.2) for a connecting device (2.2) for inductively transmitting signals according to claim 31, comprising:
a primary circuit (19.2), and
a primary coil unit (21.2) in the primary circuit (19.2), with
a primary coil (13.2) for inductive coupling with a secondary coil (11), and
at least one compensation means (31) for adjusting the coupling characteristics of the primary coil unit (21.2) to reference coupling characteristics,
wherein the at least one compensation means (31) is designed to compensate for a change in design of the primary coil unit (21.2) in relation to a reference primary coil unit (21.1).
